(19) United States
(12) Patent Application Publication
(10) Pub. No.: US 2014/0126042 A1
(43) Pub. Date: May 8, 2014

(54) SYSTEM AND METHOD TO EFFICIENTLY FILTER RADIATION ABOVE A PREDEFINED WAVELENGTH

(71) Applicant: LOCKHEED MARTIN CORPORATION, Bethesda, MD (US)

(72) Inventor: Edward J. Miesak, Windermere, FL (US)

(73) Assignee: LOCKHEED MARTIN CORPORATION, Bethesda, MD (US)

(21) Appl. No.: 14/074,873

(22) Filed: Nov. 8, 2013

Related U.S. Application Data
(60) Provisional application No. 61/724,082, filed on Nov. 8, 2012.

(51) Int. Cl. G02B 5/20

(52) U.S. Cl. CPC G02B 5/208
USPC 359/359

(57) ABSTRACT

A system including a light source and at least a first filter, having a front surface and a rear surface, positioned in a path of radiation from the light source, the at least first filter further comprising a reflective coating applied to a front surface of the at least first filter to reflect radiation off the front surface at a predefined wavelength. The front surface and the rear surface of the at least first filter are oriented in a non-parallel arrangement with respect to each other such that an angle is formed between the front surface and the rear surface. The non-parallel arrangement is configured to capture radiation unfiltered by the reflective coating and to re-direct the unfiltered radiation. Another system and a method are also disclosed.

### CROSS-REFERENCE TO RELATED APPLICATIONS

This application claims the benefit of U.S. Provisional Application No. 61/724,082 filed Nov. 8, 2012, and incorporated herein by reference in its entirety.

### BACKGROUND

Embodiments relate to an optical filter and, more particularly, to a system and method for a short-pass optical filter having a high transmission, low background, and a sharp cutoff. The term “short-pass” refers to a filter that allows shorter wavelengths to pass through unhindered while placing large losses on longer wavelengths that try passing through. The term “cut-off” refers to the transition from high transmission to low transmission. If the transition is rapid and distinct rather than gradual it is often referred to as a sharp cut-off.

Conventional short-pass filters or band pass optical filters are based on a broadband filter coating. Known short-pass vacuum ultraviolet (VUV) filters, which operate between the wavelengths of 100 nm. to 200 nm, have poor performance which includes low transmission, a sloping cut-off, and may turn back “on” at longer wavelengths. This means the filter will stop working as a filter, i.e., all wavelengths pass through with little to no loss.

Certain applications would benefit from having a more efficient short-pass or band pass optical filter which provides for a high transmission, low background, and a sharp cutoff.

### SUMMARY

Embodiments relate to a system and method to efficiently filter radiation above a predefined wavelength. The system comprises a light source and at least a first filter, having a front surface and a rear surface, positioned in a path of radiation from the light source, the at least first filter further comprising a reflective coating applied to a front surface of the at least first filter to reflect radiation off the front surface at a predefined wavelength. The front surface and the rear surface of the at least first filter are oriented in a non-parallel arrangement with respect to each other such that an angle is formed between the front surface and the rear surface. The non-parallel arrangement is configured to capture radiation unfiltered by the reflective coating and to re-direct the unfiltered radiation. Another system and a method are also disclosed.

Another system comprises a light source and a first filter. At least a second filter is provided which is positioned so that incident light from the light source initially reflects from the first filter and then from the at least second filter. The first filter and the at least second filter individually include a high reflective coating applied to a front surface of the filter to reflect radiation off the front surface at a predefined wavelength and an anti-reflective coating applied to a rear surface of the filter to transmit radiation at a wavelength to minimize loss through the rear surface. The front surface and the rear surface are oriented in a non-parallel arrangement with respect to each other such that an angle is formed between the front surface and the rear surface to capture or re-direct unfiltered radiation. The reflected light is at a wavelength to provide illumination to capture an image from a surface.

A method comprises illuminating light and directing the light towards a first filter, having a front surface and a rear surface, with a high reflective coating applied to a front surface to reflect radiation off the front surface at a predefined wavelength and with the front surface and the rear surface oriented in a non-parallel arrangement with respect to each other such that an angle is formed between the front surface and the rear surface. The method also comprises reflecting incident light from the first filter to a second filter, having a front surface and a rear surface, with a high reflective coating applied to a front surface to reflect radiation off the front surface at the predefined wavelength with the front surface and the rear surface oriented in a non-parallel arrangement with respect to each other such that an angle is formed between the front surface and the rear surface.

### BRIEF DESCRIPTION OF THE DRAWINGS

A more particular description briefly stated above will be rendered by reference to specific embodiments thereof that are illustrated in the appended drawings. Understanding that these drawings depict only typical embodiments and are not therefore to be considered to be limiting of its scope, the embodiments will be described and explained with additional specificity and detail through the use of the accompanying drawings in which:

FIG. 1 shows a schematic top view of a system;

FIG. 2 shows a plot of the irradiance versus wavelength;

FIG. 3 shows a plot illustrating intensity versus wavelength of an output of a system;

FIG. 4 shows a partial top view of a part of the system;

FIG. 5 shows a partial cross-sectional view of a front surface and a back surface of an embodiment of a filter;

FIG. 6 shows a plot of a critical angle versus wavelength for a material of an embodiment of a filter; and

FIG. 7 shows a flowchart illustrating an embodiment of a method.

### DETAILED DESCRIPTION OF THE INVENTION

Embodiments are described herein with reference to the attached figures, wherein like reference numerals are used throughout the figures to designate similar or equivalent elements. The figures are not drawn to scale and they are provided merely to illustrate aspects disclosed herein. Several disclosed aspects are described below with reference to non-limiting example applications for illustration. It should be understood that numerous specific details, relationships, and methods are set forth to provide a full understanding of the embodiments disclosed herein. One having ordinary skill in the relevant art, however, will readily recognize that the disclosed embodiments can be practiced without one or more of the specific details or with other methods. In other instances, well-known structures or operations are not shown in detail to avoid obscuring aspects disclosed herein. The embodiments are not limited by the illustrated ordering of acts or events, as some acts may occur in different orders and/or concurrently with other acts or events. Furthermore, not all illustrated acts or events are required to implement a methodology in accordance with the embodiments.

Notwithstanding that the numerical ranges and parameters setting forth the broad scope are approximations, the numerical values set forth in specific non-limiting examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 4.

Though embodiments are discussed with respect to latent fingerprints, the embodiments are also applicable to other latent markings or prints, such as, but not limited to, a footprint, a palm print, etc. Embodiments are also applicable to other surface contaminants. As used herein, “latent print” comprises a latent fingerprint and other imprints that may be recognizable to distinguish an entity from another. Latent fingerprints, which are impressions left by the friction ridges of a human finger, may be composed of almost any material, including, but not limited to, grease, oil, sweat, wax, etc. “Latent” as used with respect to fingerprints and/or other prints means a chance or accidental impression left on a surface, regardless of whether visible or invisible at time of deposition. The term “contaminant” is also used herein. This term is not limited as it can also apply to a latent print. Other non-limiting examples of a contaminant may include blood or other body fluids, oils, greases, dusts, dirt, water residue, other particulates, a fracture in a surface, a physical defect in the surface, etc.

FIG. 1 illustrates a system 10 to efficiently filter radiation above a predefined wavelength. In order to collect certain images from a surface, such as an image of a latent fingerprint from white paper, for example, a light source of short wavelength light is used. The imaging process, such as the imaging process of the latent fingerprint, is more effective, based on maintaining a light source shorter than a predefined wavelength, such as 200 nm, for example. Thus, the system 10 may be used to efficiently filter light from a light source 26, such as a Xenon flash lamp, for example, to be shorter than the predefined wavelength, and thus to eliminate all of the light with a wavelength longer than the predefined wavelength.

As further illustrated in FIG. 1, the system 10 includes filters 12,13, or optical filters, which are positioned so that incident white light 27, or radiation, from the light source 26 is initially reflected as first reflected light 29 from the first filter 12, and that the first reflected light 29 is subsequently reflected as second reflected light 28 from the second filter 13. The resulting reflected light 28 is used to illuminate an image from a surface, such as the image of a latent print or contaminant from a white paper surface, as a non-limiting example, where there is sufficient clarity so that the image of the latent print or contaminant. may be used for identification. In an exemplary embodiment, the reflected light 28 is Vacuum Ultra Violet (VUV) light with a wavelength shorter than the predefined wavelength, such as shorter than 200 nm, as a non-limiting example. Two filters are shown in this example, but more (three or more) or less than two could also be used. More specifically, one filter alone may be used, or more than two together. Generally, reflections, resulting from using more filters, should provide for better filtering. Thus, the more filters used may result in a sharper cut-off wherein shorter wavelengths may be realized resulting in a reduction of an amount of un-filtered light.

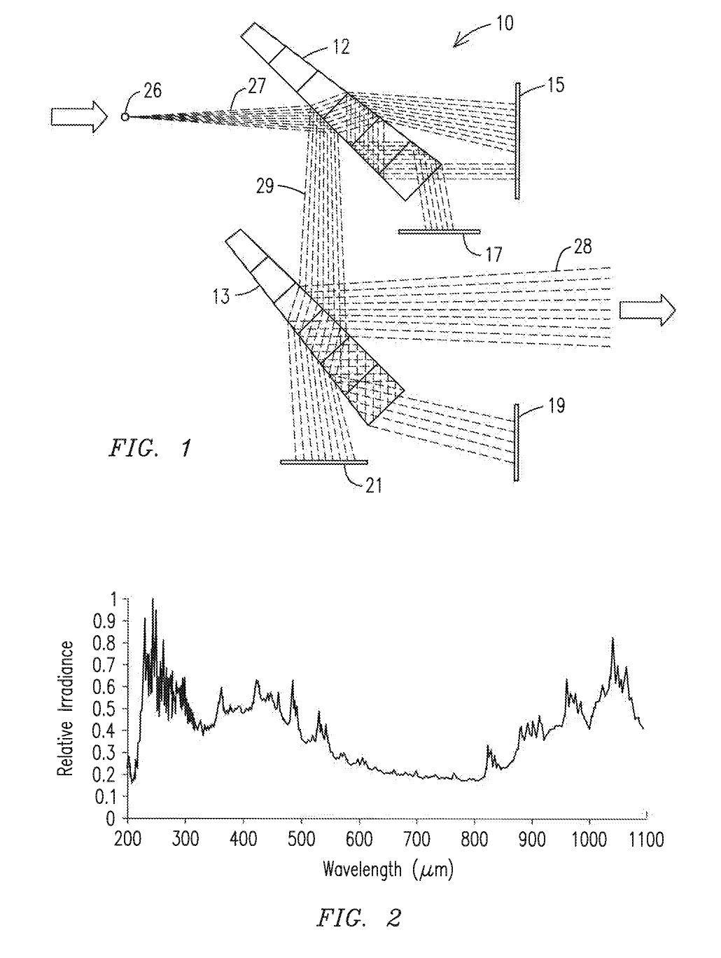

FIG. 2 illustrates a plot of the intensity versus wavelength of a Xenon flash lamp, which shows that the Xenon flash lamp emits light at a range of wavelengths some of which are longer than a predefined wavelength of 200 nm. Thus, as a non-limiting example of a Xenon flash lamp and a predefined wavelength of 200 nm, the system 10 would need to filter out all wavelengths from the Xenon flash lamp longer than about 200 nm. Light with this broad emission spectrum is commonly referred to as “white” light.

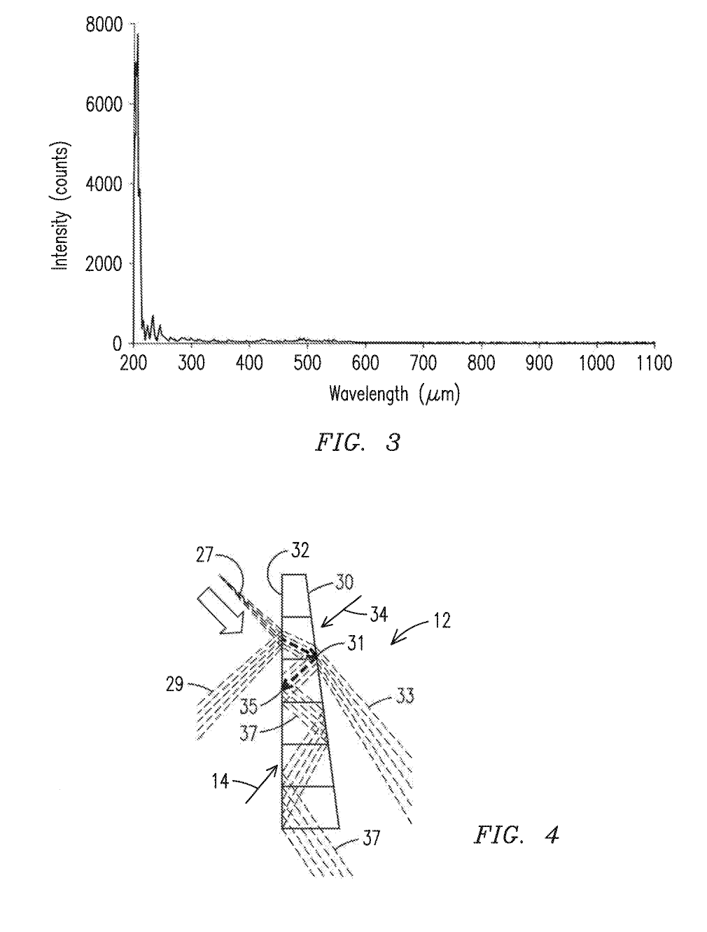

FIG. 3 illustrates a plot of the intensity versus wavelength of the reflected light 28 for an arrangement with a predefined wavelength of 200 nm, for example. This is a measured spectrum of white light shown in FIG. 2 which may have been filtered by a configuration like that shown in FIG. 1. This spectrum is the light in FIG. 1 which is labeled as 28. The cut-off is very sharp and the filter does eliminate all the light longer than about 250 nm, i.e., it does not “turn back on.”

FIG. 4 illustrates a close up view of the filter 12, which may be manufactured with the same structural features as the filter 13. Thus, the discussion of the structural features of the filter 12 is applicable to the structural features of the filter 13. The filter 12 may include a front surface 32 of an optical substrate on which a high reflection dielectric mirror coating 14 is applied. This dielectric mirror coating 14 may feature a high reflectivity at the predefined wavelength, such as 95%, as a non-limiting example, and simultaneously may feature a sharp cut off for wavelengths longer than a predefined wavelength. The dielectric mirror coating 14 may be available from several vendors, such as JDSU, QiOptiq, and CVI-MellesGriot, for example.

As discussed above, the white light 27, or radiation, from the light source 26 may be incident on the filter 12. A first reflected portion 29 of the white light with a wavelength shorter than the predefined wavelength may be reflected from the dielectric mirror coating 14 on the front surface 32, while a transmitted portion 31 of the white light is refracted into the filter 12 and reaches a rear surface 30 of the filter 12. An anti-reflection (AR) coating 34 may be applied to the rear surface 30 of the filter 12, to reduce reflection of the transmitted portion 31 of the white light from the rear surface 30 back to the front surface 32. Although FIG. 4 illustrates the AR coating 34 applied to the rear surface 30, the filter 12 may still efficiently filter radiation above the predefined wavelength without the AR coating 34.

A second transmitted portion 33 of the white light may be transmitted through the rear surface 30 and directed to a baffle 15, 19 as illustrated in FIG. 1, and thus this transmitted portion 33 may be removed from the path of the first reflected portion 29 of the white light. With respect to the back surface reflected portion 35 of the white light that reflects off the rear surface 30, the filters 12,13 are structurally configured, as discussed in greater detail below, so that the back surface reflected portion 35 may engage in total internal reflection as totally internally reflected light 37 along a length of the filters 12,13, until the light 37 is discharged from a far end of the filter 12, makes contact with an optical baffle 17, 21 and is thus removed from the path of the first reflected portion 29 of the white light. Though illustrated as being distant from the filter 12, 13, the baffles 15, 17, 19, 21 may be a part of or attached to the respective filter 12, 13.

FIG. 5 illustrates a cross-sectional view of the filter 12, with the front surface 32 and the rear surface 30 having a non-parallel alignment such that an angle β is formed between the front surface 32 and the rear surface 30. The angle β creates a wedge shape of the filter 12, or where the front surface 32 and the rear surface 30 are not parallel. A purpose of the filter 12. having the wedged shape is to allow capture of the unfiltered light and to direct the unfiltered light, or radiation, away from an optical axis of the system 10. In other words, the non-parallel surfaces provide for capture and/or re-direction of the unfiltered light.

The white light 27 is incident on the front surface 32 at an angle of θₒ, with respect to the normal N_{front} to the front surface 32. The first reflected portion 29 of the white light may be reflected from the front surface 32 at the same angle θₒ. based on Snell's law of refraction, the transmitted portion 31 of white light is refracted into the filter 12 at an angle θᵢ, defined by:

$${θ}_{i} = Arcsin \frac{{n}_{o} ( λ ) Sin {θ}_{o}}{{n}_{i} ( λ )} \qquad ( 1 )$$

The back surface reflected portion 35 of the white light off the rear surface 30 may be oriented at an angle Φ with respect to the normal N_{back} to the rear surface 30, and may be oriented at an angle α with respect to the normal N_{front} to the front surface 32. Based on the geometry of the front surface 32 and the rear surface 30, the relationship between the angles Φ, α and the angle β between the front surface 32 and the rear surface 30 may be as follows:

Φ=θᵢ+β (2)

α=θᵢ+2β (3)

In order to maintain the back surface reflected portion 35 of the white light within the interior of the filter 12, and thereby avoid the back surface reflected portion 35 from entering the reflected portion 29 of the white light, the angle α of the back surface reflected portion 35 at the front surface 32 must be greater than a critical angle for total internal reflection. When this condition is met, the back surface reflected portion 35 of the white light becomes a totally internally reflected portion 37 of the white light that passes through the dielectric filter coating 14, and exits an outer end of the filter 12 and makes contact with the optical baffle 17, as illustrated in FIG. 1. Equations (1) and (3) above are first combined:

$$α = Arcsin \frac{{n}_{o} ( λ ) Sin {θ}_{o}}{{n}_{i} ( λ )} + 2 β \qquad ( 4 )$$

Based on Snell's law, in order for the back surface reflected portion 35 to undergo total internal reflection at the front surface 32:

$$α > Arcsin \frac{ {n}_{o} ( λ )}{{n}_{i} ( λ )} \qquad ( 5 )$$

Thus, in order to design the filter 12, the angle β and the wavelength-dependent index n in equation (4) are selectively chosen, so that the angle α is greater than the critical angle quantity on the right side of equation (5), for each wavelength that is sought to be excluded above the predefined wavelength. As a non-limiting example, with regard to the Xenon flash lamp used to capture an image of a latent fingerprint from white paper and the predefined wavelength of 200 nm, the filters 12, 13 could be designed such that one or both of the angle β and the wavelength-dependent index nᵢ are selectively chosen, so that for each wavelength above 200 nm, the angle α in equation (4) is greater than the critical angle quantity on the right side of equation (5). Thus, for each wavelength above 200 nm, any back surface reflected portion 35 of the white light which was not transmitted through the filter 12 as part of the transmitted portion 33 may now undergo total internal reflection as a totally internally reflected portion 37 of the white light within the filter 12 until the light is transmitted out a far end of the filter 12, and will not enter the path of the reflected light 29 to image the surface.

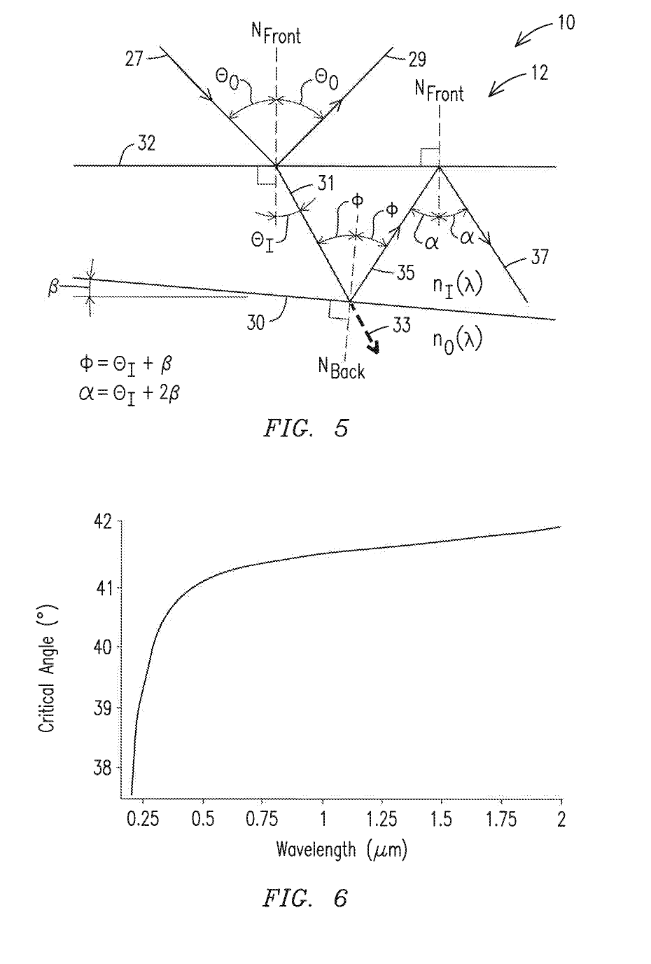

FIG. 6 illustrates a plot of a critical angle calculated for each wavelength, for a specific type of filter 12 material. Thus, in designing the filter 12 of this specific material, the angle β should be specifically chosen, so that the angle α in equation (4) is greater than the value in the plot of FIG. 6 for each wavelength longer than the predefined wavelength. Additionally, beam divergence of the light source 26 is also considered when defining the angle β to design the filter 12. A first side of the divergent white light 27 encountering the front surface 32 of the filter 12 will effectively have a higher angle θₒ, while a second side of the divergent white light 27 will have a lower angle θₒ. The higher angle θₒ for the first side of the divergent white light 27 can be accommodated by increasing the angle β accordingly.

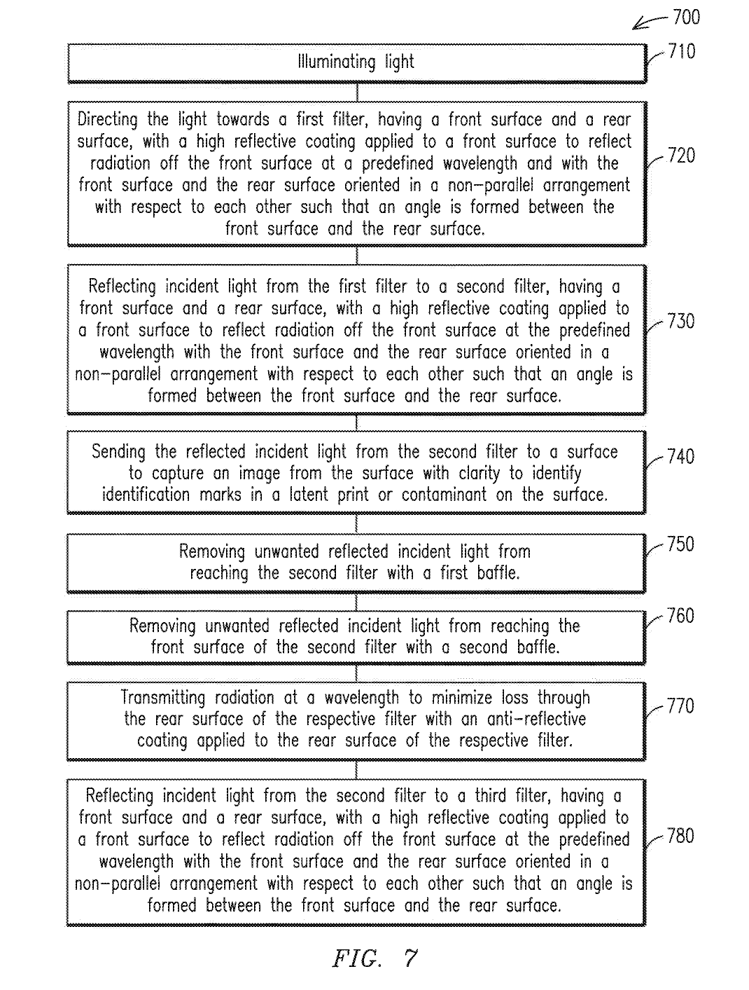

FIG. 7 illustrates a flowchart illustrating an embodiment of a method. The method 700 comprises illuminating light, at 710. The method further comprises directing the light towards a first filter, having a front surface and a rear surface, with a high reflective coating applied to a front surface to reflect radiation off the front surface at a predefined wavelength and with the front surface and the rear surface oriented in a non-parallel arrangement with respect to each other such that an angle is formed between the front surface and the rear surface, at 720. The method 700 further comprises reflecting incident light from the first filter to a second filter, having a front surface and a rear surface, with a high reflective coating applied to a front surface to reflect radiation off the front surface at the predefined wavelength with the front surface and the rear surface oriented in a non-parallel arrangement with respect to each other such that an angle is formed between the front surface and the rear surface, at 730.

The method 700 may further comprise sending the reflected incident light from the second filter to a surface to capture an image from the surface with clarity to identify identification marks in a latent print or contaminant on the surface, at 740. The method 700 may further comprise removing unwanted reflected incident light from reaching the second filter with a first baffle, at 750. The method 700 may further comprise removing unwanted reflected incident light from reaching the surface of the second filter with a second baffle, at 760. The method 700 may further comprise transmitting radiation at a wavelength to minimize loss through the rear surface of the respective filter with an anti-reflective coating applied to the rear surface of the respective filter, at 770. Since a plurality of filters may be used, the method 700 may further comprise reflecting incident light from the second filter to a third filter, having a front surface and a rear surface, with a high reflective coating applied to a front surface to reflect radiation off the front surface at the predefined wavelength with the front surface and the rear surface oriented in a non-parallel arrangement with respect to each other such that an angle is formed between the front surface and the rear surface, at 780.

While various disclosed embodiments have been described above, it should be understood that they have been presented by way of example only, and not limitation. Numerous changes to the subject matter disclosed herein can be made in accordance with the embodiments disclosed herein without departing from the spirit or scope of the embodiments. In addition, while a particular feature may have been disclosed with respect to only one of several implementations, such feature may be combined with one or more other features of the other implementations as may be desired and advantageous for any given or particular application.

Therefore, the breadth and scope of the subject matter provided herein should not be limited by any of the above explicitly described embodiments. Rather, the scope of the embodiments should be defined in accordance with the following claims and their equivalents.

The terminology used herein is for the purpose of describing particular embodiments only and is not intended to be limiting. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof are used in either the detailed description and/or the claims, such terms are intended to be inclusive in a manner similar to the term “comprising.” Moreover, unless specifically stated, any use of the terms first, second, etc., does not denote any order or importance, but rather the terms first, second, etc., are used to distinguish one element from another.

Unless otherwise defined, all terms (including technical and scientific terms) used herein have the same meaning as commonly understood by one of ordinary skill in the art to which embodiments of the invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Thus, while embodiments have been described with reference to various embodiments, it will be understood by those skilled, in the art that various changes, omissions and/or additions may be made and equivalents may be substituted for elements thereof without departing from the spirit and scope of the embodiments. In addition, many modifications may be made to adapt a particular situation or material to the teachings of the embodiments without departing from the scope thereof. Therefore, it is intended that the embodiments not be limited to the particular embodiment disclosed as the best mode contemplated, but that all embodiments falling within the scope of the appended claims are considered.

What is claimed is:

1. A system comprising:
a light source; and
at least a first filter, having a front surface and a rear surface, positioned in a path of radiation from the light source, the at least first filter further comprising a reflective coating applied to a front surface of the at least first filter to reflect radiation off the front surface at a predefined wavelength;
wherein, the front surface and the rear surface of the at least first filter are oriented in a non-parallel arrangement with respect to each other such that an angle is formed between the front surface and the rear surface; and
wherein the non-parallel arrangement is configured to capture radiation unfiltered by the reflective coating and to re-direct the unfiltered radiation.

2. The system according to claim 1, wherein the at least first filter further comprising an anti-reflective coating applied to the rear surface of the filter to transmit radiation at a wavelength to minimize loss through the rear surface.

3. The system according to claim 1, wherein the angle is selectively determined such that radiation above the predefined wavelength within the at least first filter is totally internally reflected within the filter and removed from a path of the radiation reflected off the front surface.

4. The system according to claim 1, wherein the radiation reflected comprises Vacuum Ultra Violet (VUV) light with a wavelength less than about 200 nm.

5. The system according to claim 1, wherein a material of the at least first filter is selectively determined such that radiation above the predefined wavelength within the at least first filter is internally reflected within the at least first filter and removed from a path of the radiation reflected off the front surface.

6. The system according to claim 1, wherein the non-parallel arrangement provides for a wedge shape with the angle defined by a wavelength-dependent index of refraction of a material of the at least first filter.

7. The system according to claim 1, further comprising at least one baffle.

8. A system comprising:
a light source;
a first filter; and
at least a second filter positioned so that incident light from the light source initially reflects from the first filter and then from the at least second filter;
the first filter and the at least second filter individually including:
a high reflective coating applied to a front surface of the filter to reflect radiation off the front surface at a predefined wavelength, and
an anti-reflective coating applied to a rear surface of the filter to transmit radiation at a wavelength to minimize loss through the rear surface;
wherein the front surface and the rear surface are oriented in a non-parallel arrangement with respect to each other such that an angle is formed between the front surface and the rear surface to capture or re-direct unfiltered radiation; and
wherein a reflected light is at a wavelength to provide illumination to capture an image from a surface.

9. The system according to claim 8, wherein the captured image comprises an image of a latent print or a contaminant with clarity to be used as identification.

10. The system according to claim 8, wherein the light reflected from the at least second filter comprises Vacuum Ultra Violet (VUV) light with a wavelength less than about 200 nm.

11. The system according to claim 8, wherein the angle of the first filter and the at least second filter is selectively determined such that radiation above the predefined wavelength within the respective filter is totally internally reflected within the respective filter and removed from a path of the radiation reflected off the front surface of each filter.

12. The system according to claim 8, wherein a material of each filter is selectively determined such that radiation above the predefined wavelength within each filter is internally reflected within each filter and removed from a path of the radiation reflected off the front surface of each filter.

13. The system according to claim 8, wherein the non-parallel arrangement provides for a wedge shape with the angle defined by a wavelength-dependent index of refraction of a material of the filter.

14. The system according to claim 8, further comprising at least one baffle configured to remove light.

15. A method comprising:
illuminating a light;
directing the light towards a first filter, having a front surface and a rear surface, with a high reflective coating applied to a front surface to reflect radiation off the front surface at a predefined wavelength and with the front surface and the rear surface oriented in a non-parallel arrangement with respect to each other such that an angle is formed between the front surface and the rear surface; and
reflecting incident light from the first filter to a second filter, having a front surface and a rear surface, with a high reflective coating applied to a front surface to reflect radiation off the front surface at the predefined wavelength with the front surface and the rear surface oriented in a non-parallel arrangement with respect to each other such that an angle is formed between the front surface and the rear surface.

16. The method according to claim 15, further comprising sending the reflected incident light from the second filter to a surface to capture an image from the surface with clarity to identify identification marks in a latent print or contaminant on the surface.

17. The method according to claim 15, further comprising removing unwanted reflected incident light from reaching the second filter with a first baffle.

18. The method according to claim 15, further comprising removing unwanted reflected incident light from reaching the front surface of the second filter with a second baffle.

19. The method according to claim 15, further comprising transmitting radiation at a wavelength to minimize loss through the rear surface of the respective filter with an anti-reflective coating applied to the rear surface of the respective filter.

20. The method according to claim 15, further comprising reflecting incident light. from the second filter to a third filter, having a front surface and a rear surface, with a high reflective coating applied to a front surface to reflect radiation off the front surface at the predefined wavelength with the front surface and the rear surface oriented in a non-parallel arrangement with respect to each other such that an angle is formed between the front surface and the rear surface.
